(19) United States
(12) Patent Application Publication
(10) Pub. No.: US 2014/0369636 A1
(43) Pub. Date: Dec. 18, 2014

(54) BALL BEARING ASSEMBLY TO IMPROVE LUBRICATING PERFORMANCE

(71) Applicant: MINEBEA CO., LTD., Kitasaku-gun (JP)

(72) Inventor: Joey TAGLE, Chatsworth, CA (US)

(21) Appl. No.: 13/919,985

(22) Filed: Jun. 17, 2013

(51) Int. Cl. F16C 33/66; G11B 5/48; F16C 33/38

(52) U.S. Cl. CPC F16C 33/6659; F16C 33/3887; G11B 5/4833
USPC 384/470

(57) ABSTRACT

A ball bearing includes an outer ring, an inner rind, and a plurality of balls positioned between said inner ring and said outer ring. The ball bearing further includes a retainer having a plurality of ball pockets for retaining the plurality of balls. At least one of said plurality of ball pockets includes an oil supply hole for retaining oil.

### TECHNICAL FIELD

The present invention relates to ball bearing assemblies and their design for enhanced lubrication performance. More specifically, it relates to a ball bearing assembly having a retainer with small oil supply holes for retaining oil.

### BACKGROUND OF THE INVENTION

Ball bearings are used primarily to reduce rotational friction and support radial and axial loads. They may be found in any electrical and/or mechanical devices from, for example, personal computers to passenger vehicles. In order to operate properly, ball bearings need to be lubricated with a lubricant. As a lubricant, grease, which consists of oil and/or other fluid lubricant that is mixed with a thickener such as soap, is commonly used in ball bearing assemblies.

To improve lubricating performance, retainers having ball pocket portions with an open back structure are proposed. The open back structure is positioned between two ball pockets and is formed on a back surface of the retainer. Lubricating grease is then supplied into the open back structure where a lubricant-feeding through hole allows supply of grease into an inner surface of the ball pocket portions.

To increase the amount of lubricant maintained in the retainer, concave portions formed at an opening edge of the ball pocket portions are also proposed. The concave portions are provided in addition to the open back structure of the retainers. Other structure such as, for example, retainers with lubricant feeding holes, which extend toward the balls, in axial direction are also proposed. However, all of the above-mentioned structures use a grease lubricant and thus may not meet their equivalent or maximum bearing load requirement in applications that require extremely low torque and/or narrow range of torque variation.

### SUMMARY OF THE INVENTION

In accordance with one aspect of the present invention, there is provided a ball bearing. The ball bearing includes an outer ring, an inner ring and a plurality of balls positioned between said inner ring and said outer ring. The ball bearing further includes a retainer having a plurality of ball pockets for retaining the plurality of balls, where at least one of the plurality of ball pockets includes an oil supply hole for retaining oil. A configuration where each of the plurality of ball pockets includes at least one oil supply hole is preferred.

In accordance with a second aspect of the present invention, there is provided a ball bearing. The ball bearing includes an outer ring, an inner ring, a plurality of balls positioned between said inner ring and said outer ring. The ball bearing further includes a retainer having a plurality of ball pockets on a front side for retaining the plurality of balls. A groove is also provided on a back side of the retainer for supplying lubricant to the plurality of rolling elements.

In accordance with a third aspect of the present invention, there is provided a hard disk drive for storing data. The hard disk drive includes a pivot assembly bearing which is used as a bearing member for a rotary sleeve for driving a swing arm. The pivot assembly bearing includes a sleeve and a ball bearing fitted to the sleeve wherein the ball bearing is provided with a retainer having a plurality of ball pockets for retaining a plurality of balls where at least one of the plurality of ball pockets includes an oil supply hole for retaining oil.

### BRIEF DESCRIPTION OF THE DRAWINGS

The present disclosure is described in conjunction with the appended figures:

FIG. 1 illustrates an exploded view of an embodiment of a ball bearing.

FIG. 2 illustrates a perspective view of an embodiment of a retainer.

FIG. 3 illustrates a plan view of an alternative embodiment of a retainer.

FIGS. 4A, 4B, and 4C illustrate schematic diagrams of alternative embodiments of a groove cross-section profile.

FIG. 5 illustrates torque characteristics of a pre-loaded bearing with grease and oil.

FIG. 6 illustrates an embodiment of a pivot assembly bearing.

FIG. 7 illustrates an embodiment of a hard disk drive.

In the appended figures, similar components and/or features may have the same reference label. Further, various components of the same type may be distinguished by following the reference label by a dash and a second label that distinguishes among the similar components. If only the first reference label is used in the specification, the description is applicable to any one the similar components having the same first reference label irrespective of the second reference label.

### DETAILED DESCRIPTION OF INVENTION

Embodiments of the present invention will be described hereinafter with reference to the accompanying drawings, in which preferred exemplary embodiments of the invention are shown. The ensuing description is not intended to limit the scope, applicability or configuration of the disclosure. Rather, the ensuing description of the preferred exemplary embodiments will provide those skilled in the art with an enabling description for implementing preferred exemplary embodiments of the disclosure. It should be noted that this invention may be embodied in different forms without departing from the spirit and scope of the invention as set forth in the appended claims.

This disclosure relates in general to ball bearings and their design for enhanced lubrication performance. More specifically, it relates to a new ball bearing structure with a retainer having small oil supply holes for retaining oil by capillary action.

Embodiments of the present invention are directed to a new ball bearing structure to improve lubricating performance by eliminating the effect of solid and semi-solid component of the current lubrication in pivot assembly bearings. This is achieved by adding oil supply holes with small diameters to the current retainer of the ball bearing. The oil supply holes are designed to retain lubricating oil by capillary action. In this way, lubricating oil is retained within the retainer of the ball bearing for its bearing life while operating under standard operating conditions.

Lubricant selection is of critical importance for the performance of ball bearings. It affects life, torque, speed, noise, outgassing, temperature effects, and rust prevention. Applications that require extremely low torque or narrow range of torque variation are suited to use oil as a lubricant. As an example of such applications the attention may be drawn to hard disk drives (HDDs) which are primarily used for storing data. Hard disk drives (HDDs) may include a ball bearing assembly which is used as a bearing member for a rotary shaft for driving a swing arm.

Two basic types of lubricants available are oil and grease. As explained above, applications that require extremely low torque or narrow range of torque variation are suited to use oil as a lubricant. On the other hand, grease has the advantage of being easily held within the ball bearings but causes higher torque variation compared to oil.

Oil is different from grease in that grease mainly contains base oil and a thickener, such as for example soap, while oil does not contain any thickener. Examples of different type of thickener may include urea, urea soap, and di-urea. The addition of thickener to base oil allows forming a solid or semi-solid substance that prevents oil migration from the lubrication site. However, the presence of these solid or semi-solid substances may cause read and write failures in hard disk drives (HDDs).

Examples of different type of lubricating oils, used in embodiments of the present invention, may include petroleum oil, ester oil, synthetic oil, poly-alpha-olefin (PAO) plus mineral oil, and fluorinated oil. Each of the above-mentioned lubricating oils has different operative properties in terms of temperature, volatility, and temperature/viscosity characteristics. The kinematic viscosity of lubricating oil compositions varies with temperature. The estimated range of viscosity variation is about 10 cST to about 1000 cST over an operating temperature range of 0° C. to 70° C.

The oil supply holes according to embodiments of the present invention are positioned in a way that the lubricating oil slowly leaks on the rolling elements to provide a slow but constant supply of lubrication. On the other hand, the oil supply holes are positioned such that the effect of centrifugal force does not cause the lubricating oil to flow into annular spaces, located between the inner and outer rings and the retainer, during operation of the ball bearings.

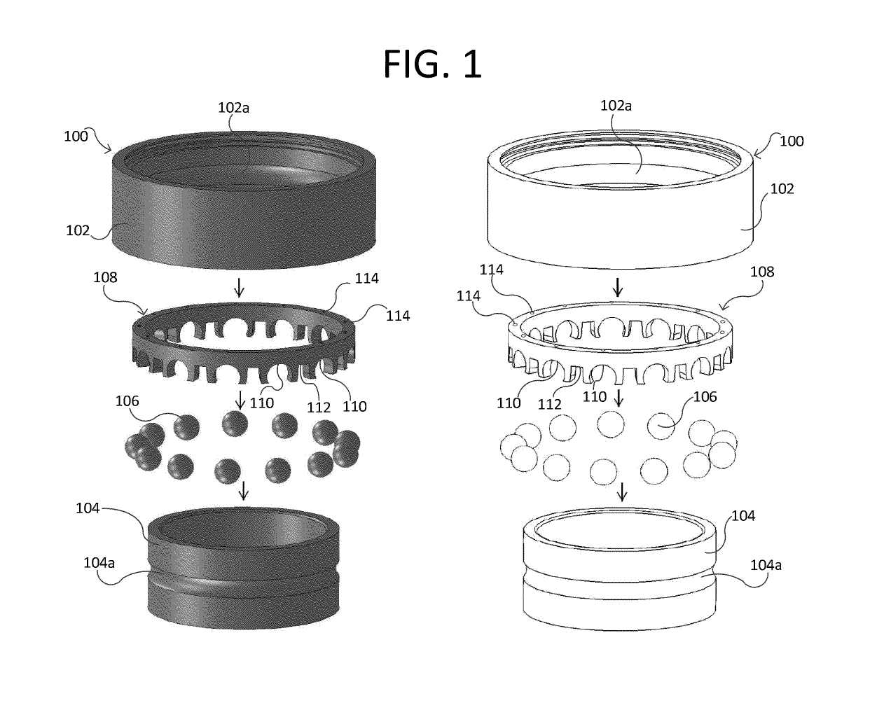

Referring first to FIG. 1, an exploded view of an embodiment of a ball bearing 100 is shown. A schematic view made by tracing the actual image of the ball bearing 100 is also provided in order to afford a better understanding. The ball bearing 100 may include an outer ring 102, an inner ring 104, and a plurality of balls 106. Each of the outer ring 102 and the inner ring 104 may include a groove 102a and 104a which are respectively disposed on an inner surface of the outer ring 102 and an outer surface of the inner ring 104. The outer ring 102 is positioned coaxially with the inner ring 104 such that the groove 102a may face the groove 104a so as to form a pathway for the plurality of the balls 106.

The ball bearing 100 further includes a retainer 108. The retainer 108 according to the preferred embodiment of the present invention may include a plurality of ball pockets 110 which are provided in a circular direction at an equal spacing on a front side of the retainer 108. In addition, as shown in FIG. 1, between each two adjacent ball pockets 110 a plane connecting portion 112 is disposed for forming a crown-shaped retainer. It should be noted that the shape of retainer 108 is not limited by the preferred embodiment and it may include any other shape, such as for example U-shaped cuts, that is adapted to retain the plurality of balls 106.

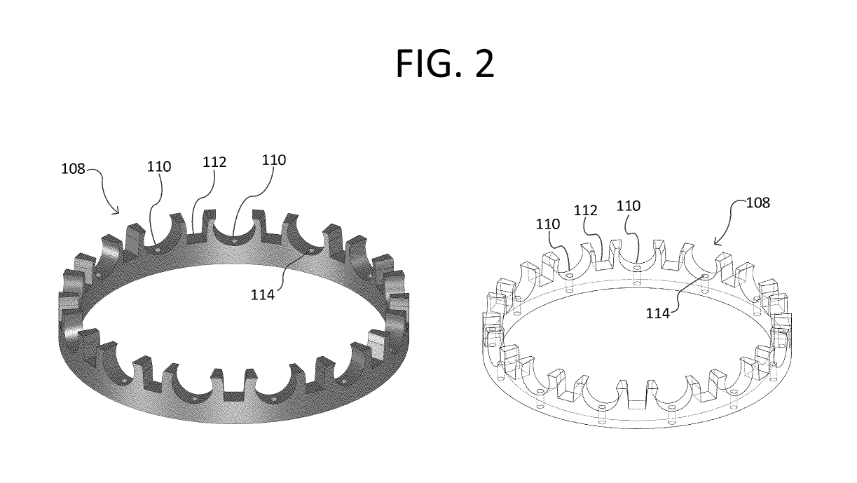

As explained above, embodiments of the present invention provide oil supply holes for retaining oil by capillary action within the retainer 108. As shown in FIG. 1 and more in detail in FIG. 2, the oil supply holes 114 are disposed to extend axially between the front side and the back side of retainer 108. As such, an inlet of at least one oil supply hole is provided on a back side of the retainer 108 while an outlet of said at least one oil supply hole is provided on an inner surface of one of the plurality of ball pockets 110. In this embodiment, the oil supply holes 114 are provided in such a way that for each of the plurality of ball pockets 110, a single oil supply hole 114 is positioned approximately at a center of said each of the plurality of ball pockets 110.

In some embodiments, multiple oil supply holes 114 may be provided for each of the plurality of ball pockets 110. In this way, the amount of lubricating oil retained within the retainer 108 is increased for the bearing life of the ball bearing assembly. For example, in one embodiment, each of the plurality of ball pockets 110 contains two oil supply holes 114 which are disposed at distal ends of said each of the plurality of ball pockets 110, compared to the position of the center. In another embodiment, three oil supply holes 114 are provided at an essentially equal distance from each other within each of the plurality of ball pockets 110.

To retain lubricating oil by means of capillary action within the retainer 108, the diameter of oil supply holes 114 are required to be as small as possible. However, there is a limit on the size of oil supply holes 114 that can be produced in a manufacturing process. In the preferred embodiment of the present invention, the oil supply holes 114 are formed to have a diameter in the range of about 0.05 mm to about 0.25 mm.

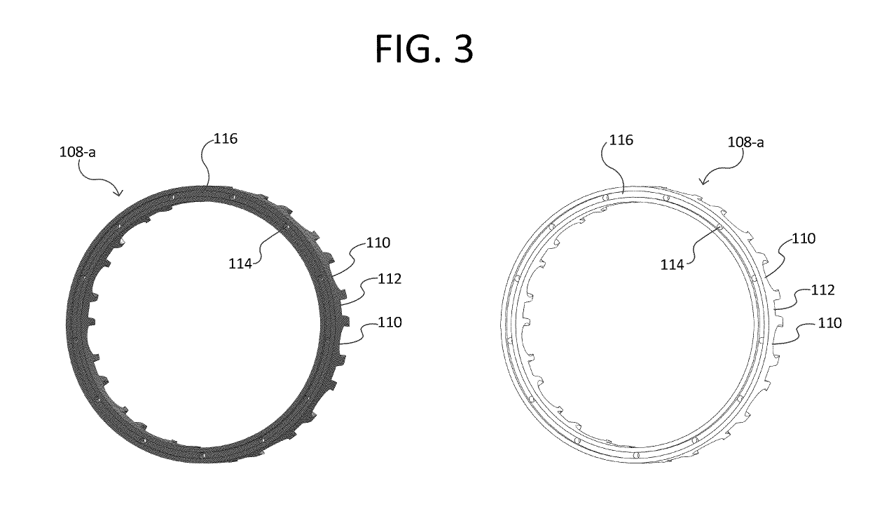

With reference to FIG. 3, a plan view of an alternative embodiment of a retainer 108-a is shown. In this embodiment, in addition to the plurality of oil supply holes 114, a groove 116 is also disposed on the back side of retainer 108-a. In this way, inlets of the plurality of oil supply holes 114 are formed at a bottom surface of the groove 116. As shown in FIG. 3, the groove 116 is provided in circular shape along an entire circumference of the back side of retainer 108-a. This design helps the oil filling process, as described below.

In the present embodiment, a lubricant dispenser unit (not shown in the figures) may be designed in such a way that lubricant can be applied into the groove 116 in any orientation. This is mainly due to the fact that the lubricating oil will flow along the groove into the plurality of oil supply holes 114. Therefore, there is no need for aligning a lubricant dispense tip with inlets of the plurality of oil supply holes 114. It is well understood that in the case where individual grooves are provided for oil retaining process, lubricating oil has to be supplied into inlets of each individual grooves. As a result, the oil filling process becomes long and costly.

In order to provide and maintain a superior capillary strength, it is required to design and form the groove 116 with a very small width. In the preferred embodiment of the present invention, the groove 116 is formed so as to have a width in the range of about 0.1 mm to about 0.3 mm. It should be noted that the width of groove 116 is slightly wider than the diameter for each of the plurality of oil supply holes 114.

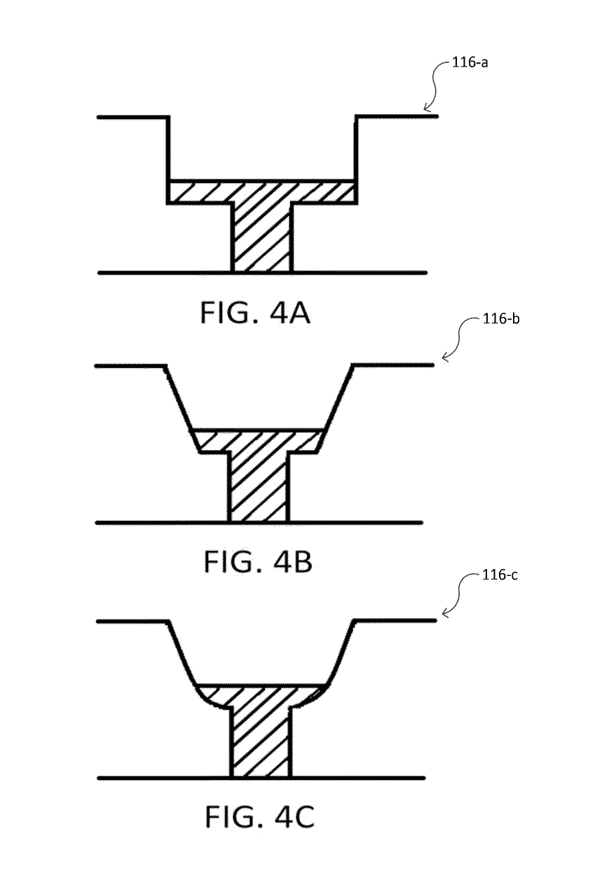

Referring next to FIGS. 4A, 4B, and 4C, schematic diagrams of alternative embodiments of a groove cross-section profile are shown. The preferable groove cross-section profile is such that the groove width at the bottom side is not larger than the groove width at open side in order to lead the oil to the bottom side. The groove 116 may be designed in various cross-section profiles for reasons of an economically feasible manufacturing process. According to one embodiment, the groove 116 may have a rectangle cross-section profile 116-a (FIG. 4A). According to another embodiment, the groove 116 may have a trapezoidal cross-section profile 116-b (FIG. 4B). According to yet another embodiment, the groove 116 may have a curved cross-section profile 116-c (FIG. 4C). For ease of manufacturing process, it is preferable that the groove 116 has a curved cross-section profile. It should be understood that the groove cross-section profile is not limited to any particular shape and it may have any other desirable shape.

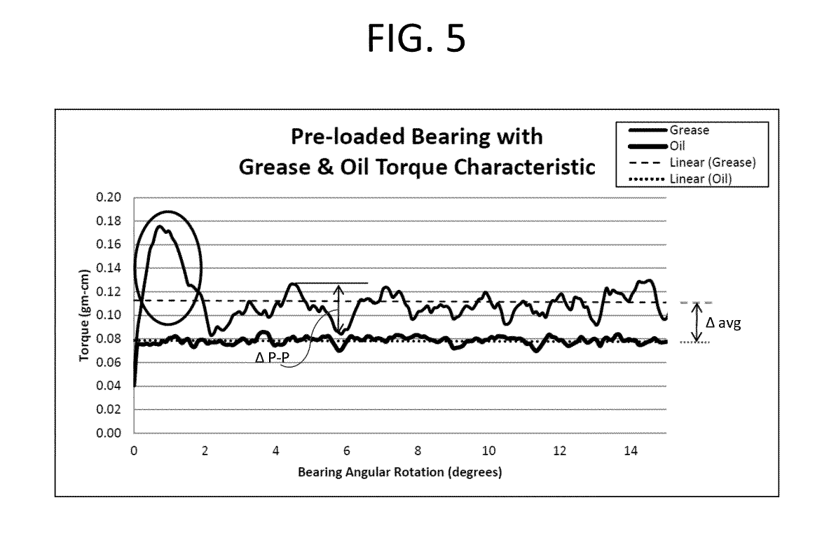

To evaluate the effect of lubricating oil over the grease the torque noise is measured for a pre-loaded ball bearing. FIG. 5 illustrates the torque characteristics over the bearing angular rotation of the pre-loaded bearing for both lubricating oil and grease. As shown in this figure, the lubricating oil shows an average torque about 0.033 gm-cm lower compared to that of the grease. In addition, the lubricating oil shows a low torque noise and torque variation (peak to peak) over the entire range of bearing angular rotation. On the other hand, grease illustrates a high torque noise and torque variation.

The pre-loaded bearing torque is measured from static condition until the bearing starts to rotate. The first portion of the torque curve, from approximately zero to two degrees, shows the bearing starting torque. As it can be seen in FIG. 5, grease has a very high starting torque compared with lubricating oil where almost no starting torque is observed. As a result, the ball bearing assemblies according to the embodiments of the present invention may eliminate almost entirely the bearing breakaway torque due to the use of lubricating oil.

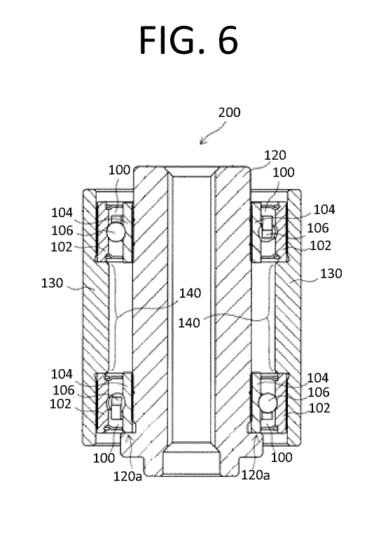

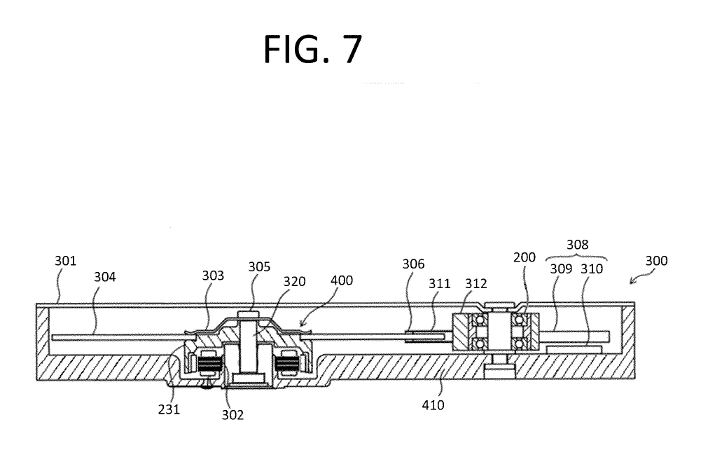

With reference to FIG. 6, an embodiment of a pivot assembly bearing 200 is shown. The pivot assembly bearing 200 is used for swingably supporting a swing arm 312 of a hard disk drive 300 shown in FIG. 7. The pivot assembly bearing 200 is configured to be fitted into a through hole of swing arm 312. The pivot assembly bearing 200 may include a shaft 120. The shaft 120 is supported in rotatable condition by two ball bearings 100 designed according to the embodiments of the present invention. As shown in FIG. 6, one ball bearing 100 is located at an upper end of the shaft 120 while the other ball bearing 100 is locate at an lower end of the shaft 120.

The inner rings 104 are attached to an outer circumference of the shaft 120 while the outer rings 102 are attached to an inner circumferential surface of a sleeve 130. During the operation of pivot assembly bearing 200, the oil retained in the oil supply holes 114 (not shown in FIG. 6) is supplied at a very slow rate to the plurality of balls 106 for lubricating purposes. On the lower end side of shaft 120, a flange 120a which has an outer diameter smaller than an inner diameter of sleeve 130 is formed. The flange 120a is attached to a lower supporting part (not shown) arranged at a base of hard disk drive 300. The outer diameter of flange 120a should desirably have a size in which a preload may be applied when the inner ring 104 is abutted.

In order to space apart the ball bearings 100 in axial direction, along the lower and upper ends of shaft 120, a spacer 140 is positioned between the outer rings 102 of ball bearings 100 within the inner circumferential surface of sleeve 130. It should be noted that the sleeve 130 and the spacer 140 may be formed integrally, as shown in FIG. 6, or as separate parts. In the following, the process for assembling the pivot assembly bearing 200 according to the embodiment shown in FIG. 6 is explained.

First, one ball bearing 100 is inserted into the shaft 120 so that an end surface of the inner ring 104 is in contact with the flange 120a. Then, the shaft 120 with the lower ball bearing 100 is inserted into inside of the sleeve 130. Consequently, the shaft 120 is fitted into the inner ring 104 of the upper ball bearing 100 and the outer ring 102 from the lower ball bearing 100 is also fitted into the lower end side of inner circumferential surface of the sleeve 130, so that the upper end surface of the outer ring 102 is in contact with the spacer 140. A UV curable anaerobic adhesive is used to bond the ball bearings 100, the sleeve 130, and the shaft 120. Finally, a preload is applied to the upper ball bearings 100 by pressing downward its inner ring 104 while the adhesive is cured. In this way, the pivot assembly bearing 200 is obtained as shown in FIG. 6.

A cross-sectional view of a hard disk drive (HDD) 300 using a spindle motor 400 is shown in FIG. 7. As shown in this figure, the spindle motor 400 is provided with a base 410 which also forms a part of a casing for the hard disk drive (HDD) 300. A cover 301 is provided for sealing an inside of the spindle motor 400, forming a clean chamber with extremely little dirt or dust. In this embodiment, the casing of hard disk drive (HDD) 300 may include the cover 301 and the base 410.

As shown in FIG. 7, one hard disk 304 (storage disk) is mounted on a rotor hub 231. The hard disk 304 is first attached to the rotor hub 231 by installing a clamp 303 and then securing the clamp 303 by screwing a center pin 305 into a screw hole of the upper end of the rotating shaft 320. Therefore, the hard disk 304 rotates as a unitary component with the rotor hub 231. The hard disk drive 300 is provided with a magnetic head 306 which implements writing and reading of data to and/or from the hard disk 304.

The magnetic head 306 is installed at one end of a head stack assembly 311 connected to the swing arm 312. The swing arm 312 is supported by a pivot assembly bearing 200 in such a way that it allows for pivoting freely from a proper location on the base 410. As shown in FIG. 7, the swing arm 312 is provided with a voice coil motor 308 moving the magnetic head 306 and the swing arm 312 to a desired position. The voice coil motor 308 may include a coil 309 and a magnet 310, which is disposed in an opposing position with respect to the coil 309.

Therefore, according to the embodiments of the present invention, the use of pivot assembly bearing 200, which includes two ball bearings 100, in the disk drive (HDD) 300 may offer high-reliability in reading/writing operations. This is mainly due to the fact that the use of oil as the main lubricant in the ball bearings 100 of the pivot assembly bearing 200 allows for meeting the specific requirements of extremely low starting torque, low torque noise, and narrow range of torque variation in hard disk drives (HDD) 300.

It should be understood that depending on the application, it is possible that an oil lubricant may not meet a specific requirement. As a result, for those specific applications, grease may also be used in various embodiment of the present invention as the main lubricant.

While the principles of the disclosure have been described above in connection with specific apparatuses and methods, it is to be clearly understood that this description is made only by way of example and not as limitation on the scope of the invention.

What is claimed is:

1. A ball bearing comprising:
an outer ring;
an inner ring;
a plurality of balls positioned between said inner ring and said outer ring; and
a retainer having a plurality of ball pockets for retaining the plurality of balls, wherein at least one of said plurality of ball pockets comprises an oil supply hole for retaining oil.

2. The ball bearing as recited in claim 1, wherein each of said plurality of ball pockets comprises at least one oil supply hole.

3. The ball bearing as recited in claim 1, wherein the oil in said oil supply hole is retained by capillary action.

4. The ball bearing as recited in claim 1, wherein said oil supply hole comprises a diameter in the range of about 0.05 mm to about 0.25 mm.

6. The ball bearing as recited in claim 1, wherein said ball pocket comprises multiple oil supply holes.

7. The ball bearing as recited in claim 1, wherein an inlet of said oil supply hole is provided on a back side of the retainer while an outlet of said oil supply hole is provided on an inner surface of each of said plurality of ball pockets.

8. A ball bearing comprising:
an outer ring;
an inner ring;
a plurality of balls positioned between said inner ring and said outer ring; and
a retainer having a plurality of ball pockets on a front side for retaining the plurality of balls, wherein a groove is provided on a back side of the retainer for supplying lubricant to said plurality of balls.

9. The ball bearing as recited in claim 8, wherein the groove is provided along an entire circumference of the back side of said retainer.

10. The ball bearing as recited in claim 8, wherein the groove has a width in the range of about 0.1 mm to about 0.3 mm.

11. The ball bearing as recited in claim 8, wherein the groove has a width at a bottom side of the groove which is not larger than a width at an open side of the groove.

12. The ball bearing as recited in claim 11, wherein the groove has a rectangular, trapezoidal, or curved cross-section profile.

13. The ball bearing as recited in claim 8, wherein the lubricant comprises grease.

14. The ball bearing as recited in claim 8, wherein the lubricant comprises oil.

15. The ball bearing as recited in claim 8, wherein at least one of the plurality of ball pockets comprises a through hole for retaining lubricant.

16. The ball bearing as recited in claim 15, wherein an inlet of said through hole is provided at a bottom surface of the groove.

17. A pivot assembly bearing for rotating a swing arm supporting a magnetic head in a hard disk drive, the pivot assembly bearing comprising at least one ball bearing, said at least one ball bearing comprises:
a retainer having a plurality of ball pockets for retaining the plurality of balls, wherein at least one of said plurality of ball pockets comprises an oil supply hole for retaining oil.

18. The pivot assembly bearing as recited in claim 17, wherein a groove is provided along an entire circumference of a back side of the retainer for supplying oil to said oil supply hole.

19. A hard disk drive for storing data comprising a pivot assembly bearing according to claim 17.

20. A hard disk drive for storing data comprising a pivot assembly bearing according to claim 18.
